(19) United States
(12) Patent Application Publication
(10) Pub. No.: US 2014/0159392 A1
(43) Pub. Date: Jun. 12, 2014

(54) CONCEALED FASTENER LOCKSET

(71) Applicants: Ping Hsien Tsai, Walnut, CA (US); Birk Cliff Sorensen, Whittier, CA (US); Louis Romo Martinez, JR., Montebello, CA (US)

(72) Inventors: Ping Hsien Tsai, Walnut, CA (US); Birk Cliff Sorensen, Whittier, CA (US); Louis Romo Martinez, JR., Montebello, CA (US)

(73) Assignee: EMTEK PRODUCTS, INC., City of Industry, CA (US)

(21) Appl. No.: 14/183,326

(22) Filed: Feb. 18, 2014

Related U.S. Application Data
(63) Continuation-in-part of application No. 13/940,178, filed on Jul. 11, 2013.
(60) Provisional application No. 61/672,259, filed on Jul. 16, 2012.
(60) Provisional application No. 61/672,259, filed on Jul. 16, 2012.

(51) Int. Cl. E05B 9/00

(52) U.S. Cl. CPC E05B 9/00
USPC 292/336.3

(57) ABSTRACT

Locksets primarily intended for use in interior residential doors and that have a concealed fastener mechanism positioned on one side of the lockset, the mechanism including connecting a first handle connected to a second handle through a spindle with the concealed fastener mechanism comprising a generally cylindrical housing including a torsion spring, a timing plate and a cover plate, the housing including an internally threaded central aperture, the timing plate including at least one tab adapted to cooperate with said torsion spring to return the handle to its at-rest position after rotation, a spindle expansion and stabilizing screw adapted to eliminate any gap between the spindle and the timing plate and a spindle set screw that, when engaged eliminates any gap between the spindle and its handle to thereby eliminate the “wobble” that otherwise could be in the lockset.

### CROSS REFERENCE TO RELATED APPLICATION

This application is a continuation-in-part of and claims the benefit of priority of U.S. application Ser. No. 13/940,178, filed Jul. 11. 2013, which claims the benefit of priority of U.S. provisional patent application 61/672,259, filed Jul. 16, 2012, both of which are incorporated by reference herein.

### FIELD OF INVENTION

The invention relates to the field of door locksets, including but not limited to interior doors such as interior passage and privacy locksets.

### BACKGROUND

Typical conventional door passage locksets include a handle or actuator that may be a knob or a lever. The locksets also include a spindle, a rosette on each side of the door and mounting screws that hold the lockset together and that are exposed on one of the rosettes.

### SUMMARY

The present concealed fastener locksets include embodiments of concealed fastener mechanisms that may be used with conventional knob and lever locksets that conceal the mounting screws on the rosette, that eliminate gaps or clearances between the lockset spindle and its timing plate and that eliminate gaps or clearances between the lockset spindle and the handles of the lockset. The present concealed lockset mechanisms provide for sleek, concealed fastener systems with no exposed screws and that can be used in brass, stainless steel, bronze, zinc, steel, aluminum, crystal and porcelain interior passage and privacy locksets. The present locksets include a concealed fastener cartridge adapted for use with a knob handle, and a cartridge adapted for use with a lever handle. Both types of locksets accommodate a privacy feature. Locksets of this type often exhibit what is known as a “wobble”, due to the existence of a small clearance between the spindle of the lockset and its timing plate, and between the spindle and the lockset' s handle. Elimination of this wobble problem is provided in the present lockset, through use of an expandable spindle part and a set screw in combination with the expandable spindle part.

Numerous features, aspects, and advantages of the present concealed fastener locksets will become better understood with regard to the following description, appended claims and accompanying drawings.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 is a perspective, exploded view of a preferred knob handle embodiment of the present concealed fastener lockset assembly including a display block;

FIG. 2 is a perspective, exploded view of the lockset assembly of FIG. 1;

FIG. 3 is a close up, perspective, exploded view of the concealed fastener mechanism of the FIG. 1 embodiment;

FIG. 4 is a close up, perspective, exploded view of a concealed fastener mechanism for an alternate concealed fastener lockset embodiment;

FIG. 5A is a perspective view of the concealed fastener lockset spindle assembly disassembled;

FIG. 5B is a perspective view of the FIG. 5A concealed fastener lockset spindle assembly assembled;

FIG. 5C is a cross-sectional view of the FIG. 5A concealed fastener lockset spindle assembly;

FIG. 5D is a view of the joining regions of the FIG. 5A concealed fastener lockset spindle assembly encircled in FIG. 5C;

FIG. 6 is a perspective, exploded view of a preferred lever handle embodiment of the present concealed fastener lockset assembly;

FIG. 7 is a cross-sectional view of an alternate embodiment spindle assembly;

FIG. 8 is a transverse cross-sectional view of the FIG. 7 embodiment spindle assembly taken along line A-A of FIG. 7;

FIG. 9 is a transverse cross-sectional view of the FIG. 7 embodiment spindle assembly taken along line B-B of FIG. 7;

FIG. 10 is a perspective, exploded view of the FIG. 7 embodiment spindle assembly used with a lever handle;

FIG. 11 is a perspective view of the FIG. 7 embodiment spindle assembly used with a lever handle, showing interior components in dashed lines;

FIG. 12 is a perspective, cut away view of the FIG. 7 embodiment spindle assembly used with a lever handle, showing interior components in the cut away area;

FIG. 13 is a perspective, exploded view of the FIG. 7 embodiment spindle assembly used with a knob handle;

FIG. 14 is a perspective view of the FIG. 7 embodiment spindle assembly used with a knob handle, showing interior components in dashed lines; and,

FIG. 15 is a perspective, cut away view of the FIG. 7 embodiment spindle assembly used with a knob handle, showing interior components in the cut away area.

Reference symbols or names are used in the figures to indicate certain components, aspects or features shown therein. Reference symbols common to more than one figure are specific to the referenced figure and may or may not indicate like components, aspects or features shown in other figures.

### DETAILED DESCRIPTION

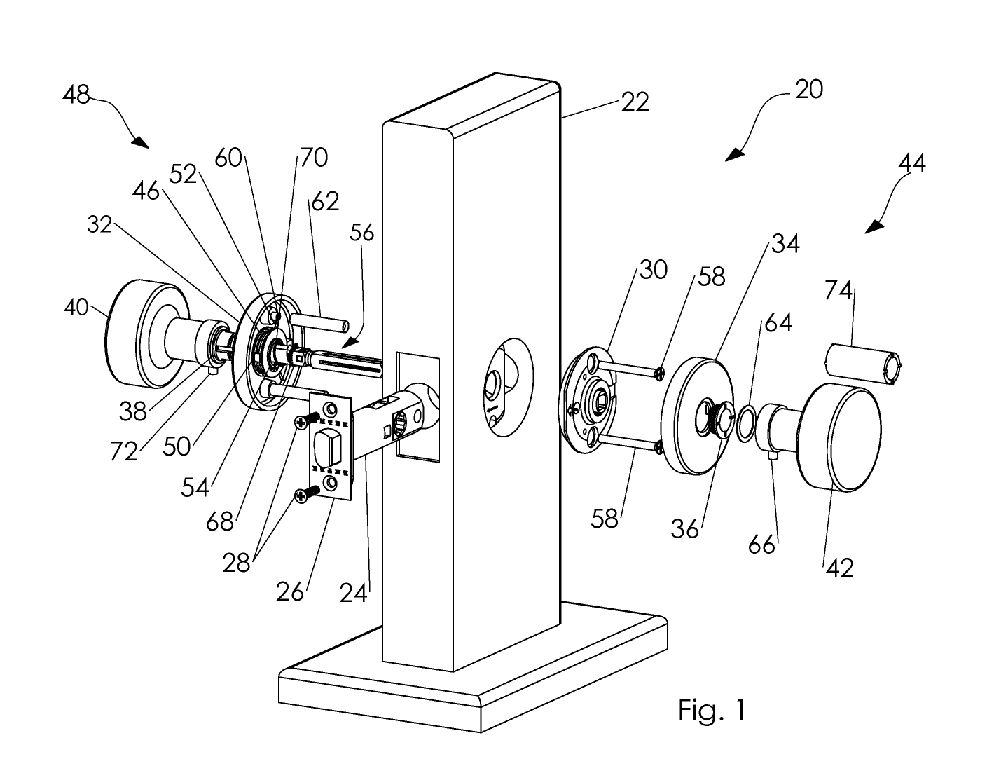

With reference to FIG. 1 a complete assembly of a preferred embodiment 20 of the present concealed fastener locksets is shown. For convenience and ease of reference the lockset 20 is shown placed in a display block 22, which in normal consumer use would be an entire, interior door. Latch 24 and face plate 26 are shown as adapted to be inserted into the display block 22 and retained in the block with conventional Phillips screws 28.

A preferred embodiment concealed fastener mechanism cartridge is shown at 30. The cartridge 30 may also be referred to as a cassette 30, but for convenience and consistency will be referred to as a cartridge. The cartridge 30 is positioned on one side of the door (the “concealed side” or a “first side”), which can be “inside” or “outside” relative to other structures of the home or other building in which the door is positioned. For example, in residential use the cartridge 30 could be placed on either side of the door. The FIG. 1 embodiment lockset and its cartridge 30 are for use with a knob lockset. An alternate preferred embodiment lockset and cartridge are for use with a lever lockset. Rosette 32 is positioned on the side of the door that is opposite the concealed side of the door (the “second side”), and a corresponding rosette 34 is positioned on the concealed side of the door. Rosette fastener ring nut 36 is externally threaded and is adapted to be screwed into the cartridge 30, causing the rosette 34 to abut against the door. As will be appreciated by those skilled in this field, the lockset embodiments described herein are particularly advantageous because they eliminate the need to manufacture one lockset for a “left-handed” door and a different lockset for a “right-handed” door. Rather the same lockset, as described herein, may be used for either a “right-handed” door or a “left-handed” door.

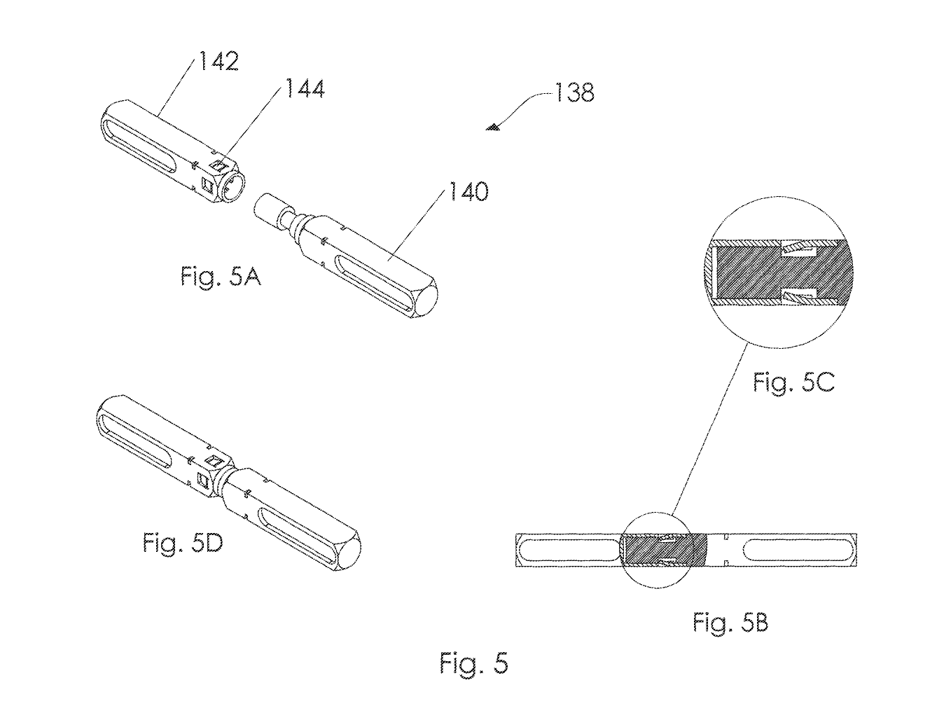

Conventional shoulder washer 38 and knob 40 are shown on the second side of the door. Knob 42 is on the concealed or first side of the door and is adapted to be used with the concealed fastener mechanism 44. Shim spacer 46 is in the knob assembly 48 on the second side. Timing plate 50 is also positioned on the second side of the door and it functions to hold down rotational return spring 52. Conventional c-clip 54 holds the knob assembly 48 together. A preferred embodiment concealed fastener split spindle assembly is generally shown at 56 and with details shown in FIGS. 5A-5D.

Pairs of machine screws 58, set screw sockets 60 and socket posts 62 function to hold the two knob assemblies together. Washer 64, preferably made of a relatively hard, elastomeric material functions to reduce friction on knob 42 as it is rotated in either direction. Set screw 66 functions to retain knob 42 on the spindle 56 on the concealed side of the lockset, and corresponding set screw 72 retains knob 40 on the second side of the door. Preferably the set screws 66, 72 are for use with an Allen wrench.

Conventional spindle clip 68 on the spindle 56 functions to set the distance that the spindle is inserted into the latch 24. Cone spring 70 functions to bias the spindle 56 away from knob 40 and toward knob 42. Set screw 72 is positioned in knob 40 and serves two functions. First set screw 72 prevents spindle 56 from escaping from knob 40, while permitting limited reciprocation of the spindle 56. Secondly, once spindle 56 has been inserted through the latch 24 mounted in the door and c-clip 54 abuts against latch 24, then set screw 72 is tightened down to secure spindle 56 for proper operation of the lock. The thickness of the particular door determines when the c-clip 54 abuts against latch 24. With a relatively thin door, relatively more of the spindle will be contained within the knob 40, and with a relatively thick door relatively less of the spindle will be contained within the knob 40.

Tool 74 is adapted to rotate to tighten or loosen and remove rosette ring nut 36. Tool 74 is preferably made of a metal or of a polymeric material that is of sufficient hardness and strength to enable tightening of the ring nut 36 by hand or by a wrench or pliers. Tool 74 may have two or more flat surfaces to enable operation with pliers or a wrench. As shown in FIG. 1 rosette ring nut 36 has four rectangular-shaped female indentations, preferably located 90° apart from each other, and tool 74 has four corresponding, complementary male protrusions adapted for cooperation with the indentations on the ring nut 36. Other complementary shapes and forms may be used.

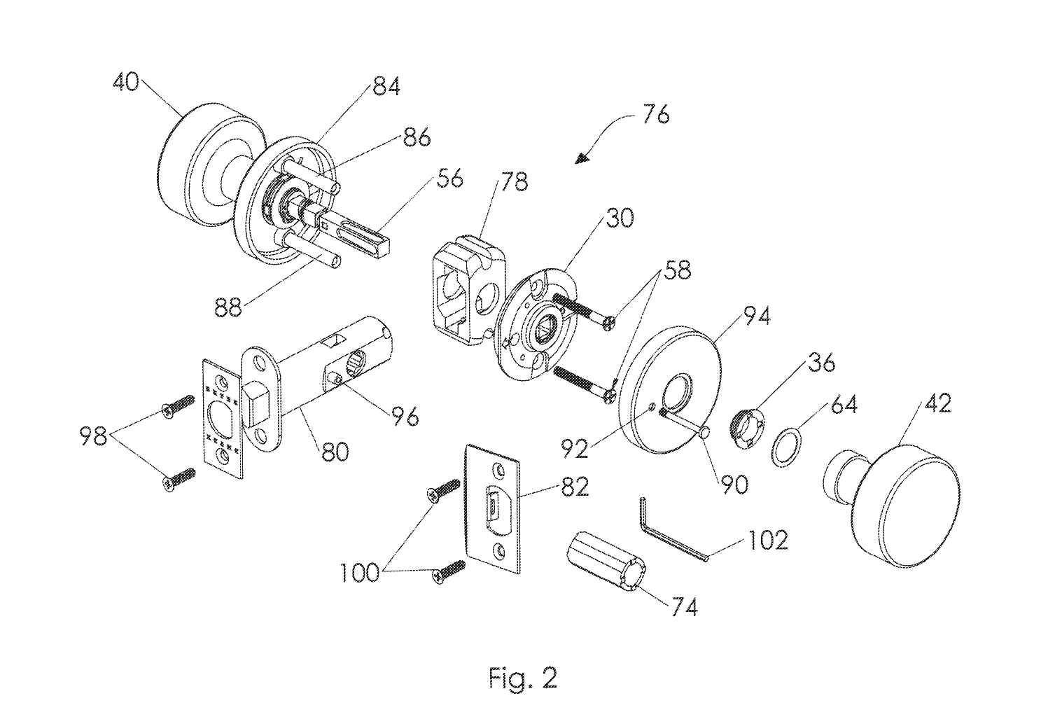

Referring to FIG. 2, an exploded view of an alternate embodiment 76 of the concealed fastener mechanism is shown, including the addition of a preferred post alignment device 78, a privacy latch 80 and a strike plate 82. The FIG. 2 post alignment device 78 is preferably of a sturdy polymeric material. The device 78 functions to keep privacy rosette 84 from rotating during use, and is adapted to secure the latch 80 and to align the posts 86, 88 along the top and bottom grooves of the mechanism 78.

Again referring to FIG. 2, the privacy assembly includes privacy pin 90 which extends through a hole 92 in the rosette 94 and threads into the privacy latch 80 at the privacy latch trigger shown at 96. The FIG. 2 latch 80 is fastened to the door with wood screws 98. FIG. 2 also shows conventional strike plate 82 and wood screws 100, preferably of the same type and size as the wood screws 98 used for the latch 80. The FIG. 2 latch 80 differs from the FIG. 1 latch 24 in that the FIG. 2 latch 80 includes the privacy assembly and preferably is a 28° rotation latch. The FIGS. 1 and 2 latches 24, 80 may also provide for different degrees of rotation required to latch and unlatch the lockset. Preferably the FIG. 2 latch 80 is configured to latch and unlatch with a 28° rotation. Conventional latches also typically are made to operate with a rotation in the range of 45°-60°, for example a 50° rotation. The privacy pin 90 operates simply by pushing to lock the door. As the door handle (knob or lever) is rotated from the same side, the privacy mechanism operates to unlock the latch so that there is no need to withdraw the pin 90. Allen wrench 102 is shown in FIG. 2, and may be used to tighten or loosen the set screws in the handles of the locksets. Tool 74 is also shown in FIG. 2 and is described with respect to FIG. 1.

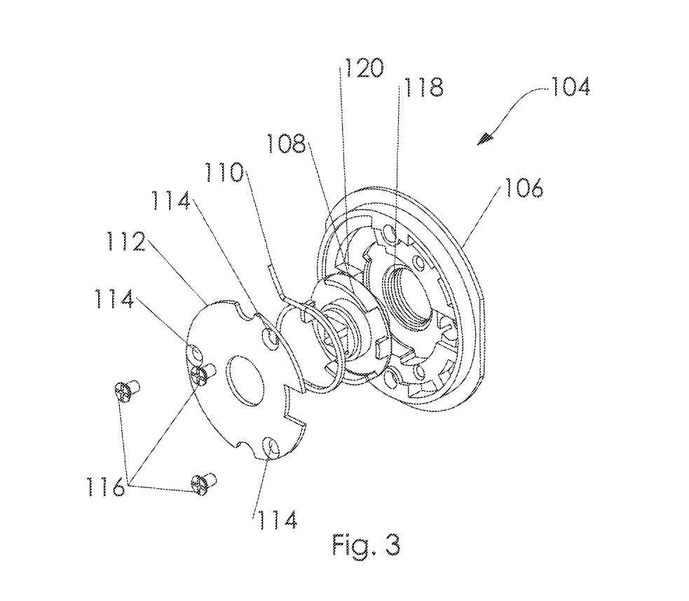

Referring to FIG. 3 an exploded view of a preferred cartridge spring assembly 104 for use with a knob is shown. Concealed fastener spring housing 106 houses knob timing plate 108 and knob spring 110. The spring 110 and plate 108 are held in place by cover plate 112 having three holes 114 and three machine screws 116. The housing 106 includes internal threads 118 to accommodate the external threads of the rosette ring nut 36.

The knob timing plate 108 functions to keep the spindle 56 aligned with latches 24 and 80. The distal end of spring 110 extends at a right angle from the periphery of the spring 110 and functions as a stop to rest against shoulder 120 in the housing 106.

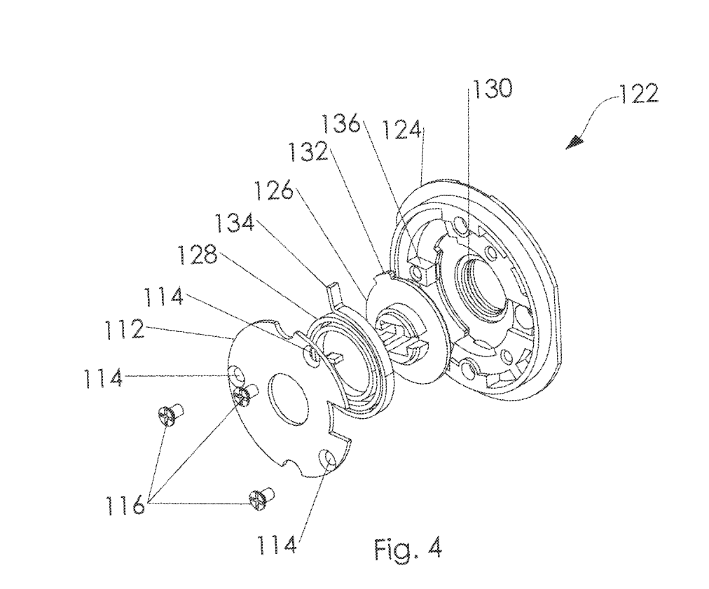

With reference to FIG. 4, a preferred cartridge spring assembly 122 for use with a lever is shown. Concealed fastener spring housing 124 houses lever timing plate 126 and lever return spring 128. Spring housing 124 for the lever embodiment is preferably of the same construction as the spring housing 106 for the knob embodiment shown in FIG. 3. Again referring to FIG. 4, the timing plate 126 and spring 128 are held in place by housing cover plate 112, having three holes 114 and three machine screws 116. The lever spring housing 124 includes internal threads 130 to accommodate the external threads of the rosette ring nut 36 of FIGS. 1 and 2. The timing plate 126 for the lever embodiment is of a different construction than the timing plate 108 for the knob embodiment. The FIG. 4 lever timing plate 126 preferably has a single tooth or projection 132. In one preferred embodiment the tooth 132 is adapted for only a 28° rotation for latching/unlatching. Conventional coil spring 128 has a distal end 134 which extends 90° from the outer coil of the spring 128 and abuts either side of shoulder 136 in the housing 124.

Referring to FIGS. 5A, B, C and D, a preferred concealed fastener spindle assembly 138 is shown. FIG. 5A shows the disassembled split spindle male member 140 and female member 142 preferably having four rectangular tabs, one of which is shown at 144. Each of the tabs 144 has three sides cut-out and one side attached to the s top surface of the female member 142. Preferably, such tabs 144 are included on the top, bottom and both sides of the female member 142. FIG. 5B is a cross-sectional view of the assembled spindle assembly 138, showing two of the four tabs crimped inward toward the center, and FIG. 5C is a close-up, showing the crimped tabs 144 in greater detail. The crimped tabs 144 function to permit rotation of the two spindle members 140, 142 relative to each other, and to prevent the two members from separating from each other during normal use. FIG. 5D shows the assembled split spindle 138. The split spindle is preferably used for both the knob and lever embodiments of the concealed fastener locksets.

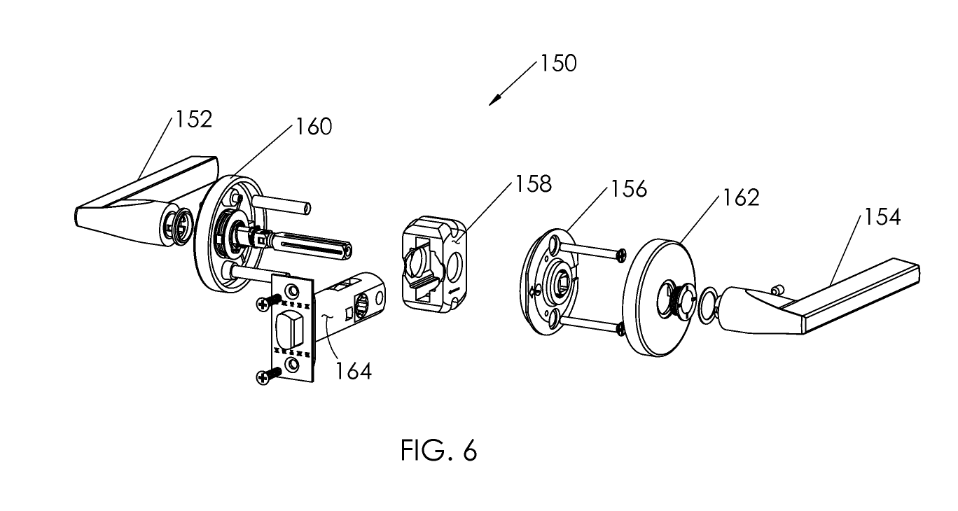

Referring to FIG. 6, an exploded view of a preferred lever handle embodiment 150 of the present concealed fastener lockset assembly shows major components lever 152, lever 154 and cartridge 156. A post alignment device 158, rosettes 160 and 162 and latch 164 are also shown in FIG. 6 and are as described above.

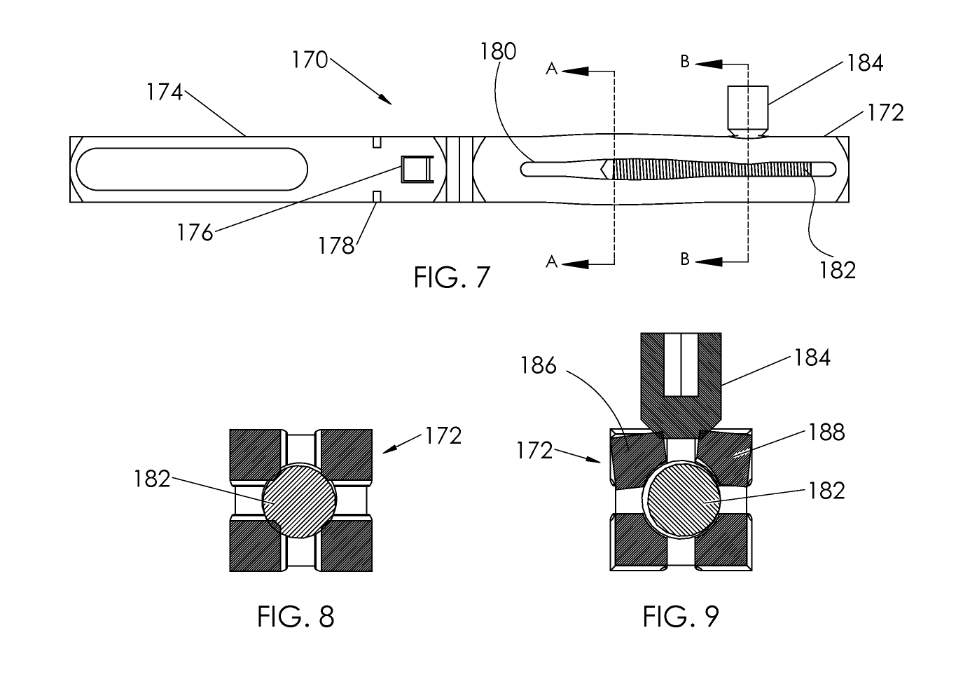

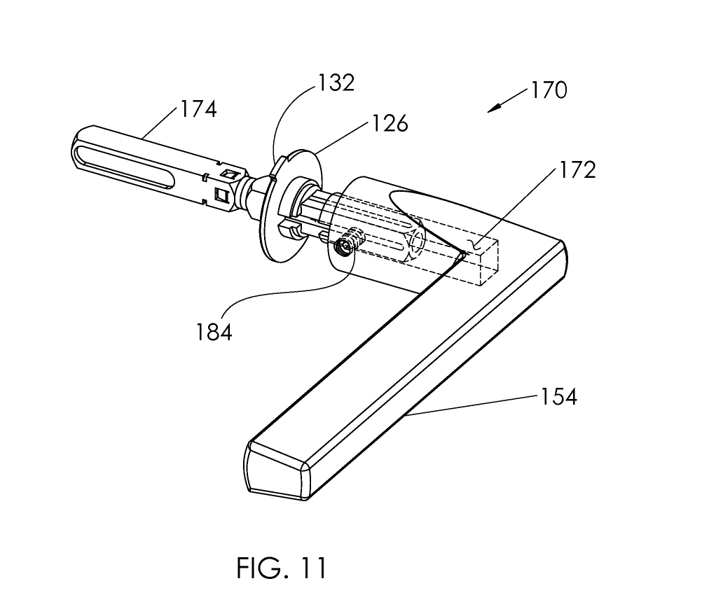

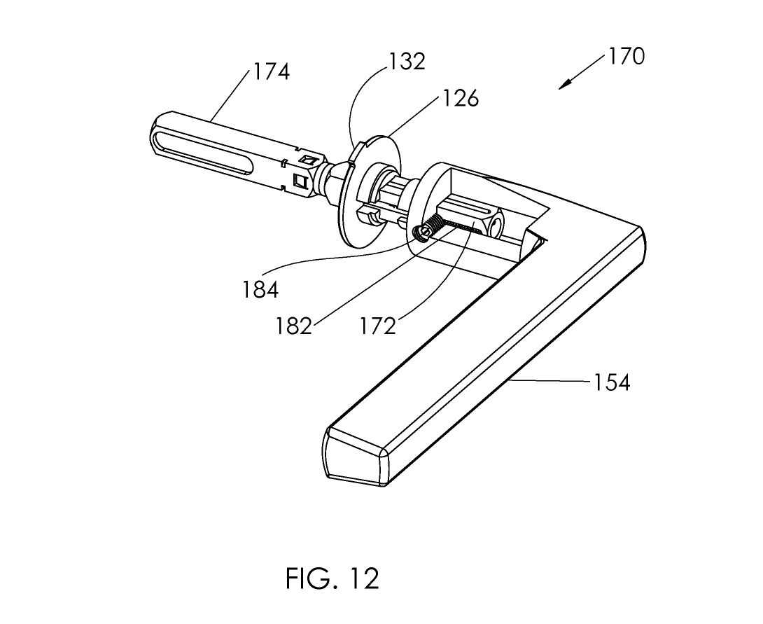

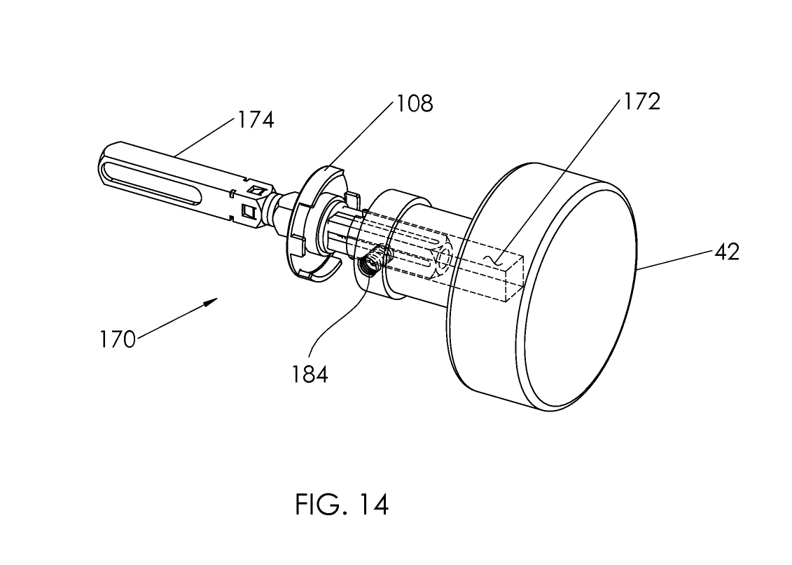

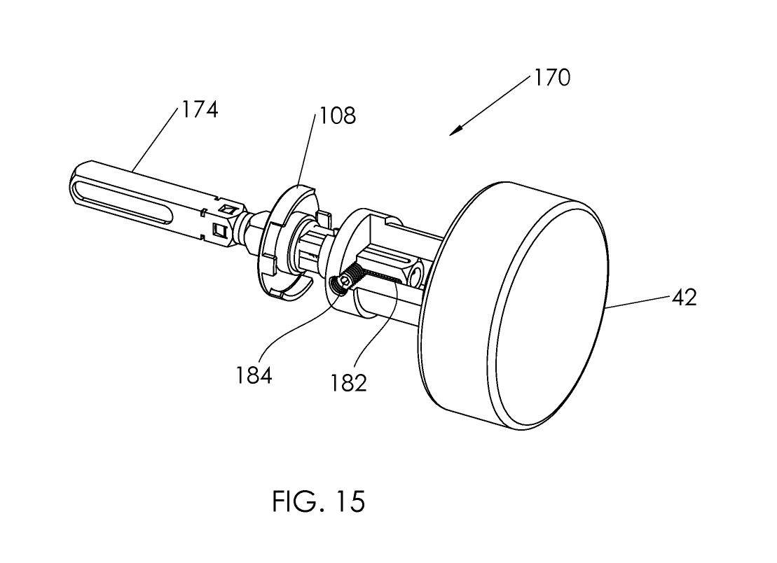

Referring to FIGS. 7-15 an alternate preferred concealed fastener spindle assembly 170 is shown. FIG. 7 is shows the assembled split spindle male member 172 and female member 174 showing one of the four rectangular tabs, shown at 176 and described above. Channel 178 in female member 174 provides the channel for capturing spindle clip 68, which in turn sets the distance the spindle is inserted into the latch. Male member 172 includes a central, threaded channel 180 and an interior spindle stabilizing screw 182. As the stabilizing screw 182 is rotated into the channel 180, the leading edge of the screw 182 forces a slight expansion of the outer walls of the member 172 radially outward. In the absence of stabilizing screw 180 there would be a clearance between the outer periphery of the male member 172 (at the cartridge side of the lockset) and the timing plate of the lockset. As will be described in detail, the leading edge of the screw 182 eliminates this clearance. The distal, or opposite end of the screw 182 is preferably adapted to receive an Allen wrench.

With insertion of the stabilizing screw 182 into the longitudinal cavity of the male member 172, the four sides of the male member of the spindle are expanded at the leading edge of the screw 183, the clearance between the spindle and the timing plate is eliminated. To address any clearance between the spindle and the handle (knob or lever) the distal end of set screw 184 is provided and adapted to contact the male member of the spindle. Set screw 184, also preferably adapted for an Allen wrench driver is shown in FIGS. 7 and 9. The FIG. 7 embodiment split spindle is preferably used for both the knob and lever embodiments of the concealed fastener locksets.

FIG. 8 is a cross-sectional view of the spindle male member 180 at line A-A and shows the channel inside of the male member at a location remote from the set screw 184. At this location, the leading edge of expansion screw 182 is shown causing a slight expansion of the spindle. When screw 182 is threaded into the internal, threaded channel of the male member 172, FIG. 8 shows the expansion at line A-A, and reduction of the overall potential wobble effect by eliminating clearance between the spindle and the timing plate 126, or timing plate 108 for the lever handle or knob handle embodiments, respectively as shown in FIGS. 3 and 4.

FIG. 9 is a cross-sectional view of the spindle male member 180 at line B-B, through the location of the centerline of set screw 184. At this location and with set screw 184 rotated or threaded inward to “set” the spindle, screw 184 functions to eliminate any clearance between the male member of the spindle and the handle, and thus to eliminate any remaining wobble in the lockset. Threading the screw 184 inward and up against the male member 172 forces distortion of regions 186 and 188. Rotation of the set screw 184 inward (downward in FIG. 9) and against the male member 172 forces region 186 outward (to the left in FIG. 9) and against stabilizing screw 182, which is then forced downward and to the right in FIG. 9. The rotation of the screw 184 inward to contact against the walls of the male member 172 [stop] also forces region 188 outward (to the right in FIG. 9) and against the stabilizing screw 182 as shown in FIG. 9. The insertion of the set screw 184 in this way expands the outer periphery of the male spindle member in the region adjacent the contact points of the screw 184 to the spindle and in turn the outer part of the spindle to the inner surface of the handle. By expanding this region of the spindle, any remaining clearance between the spindle and its handle is removed, thus removing the “wiggle” or “wobble” that otherwise would result from the existence of such clearance.

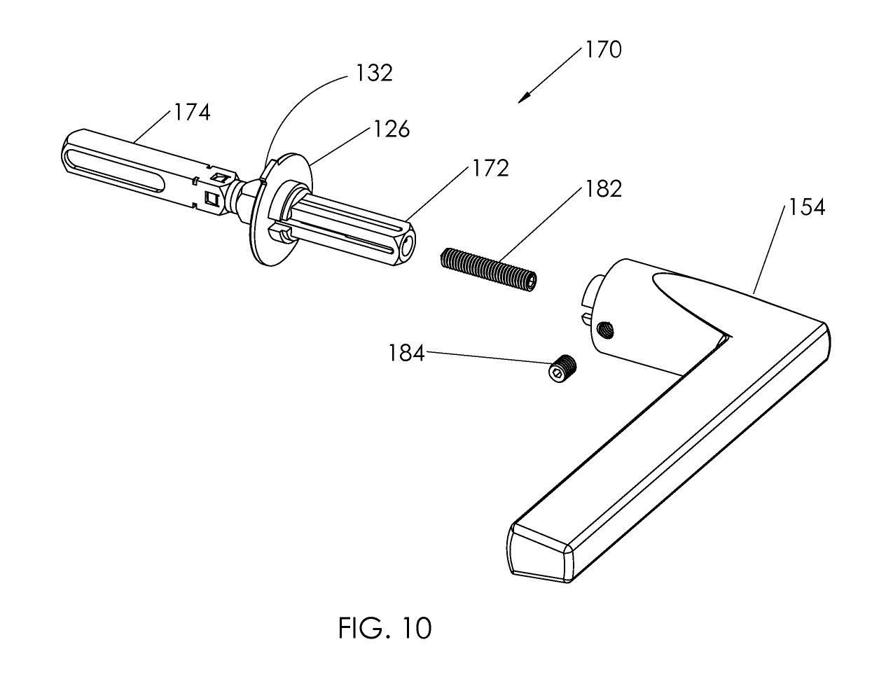

Referring to FIGS. 10-12, spindle assemble 170 is shown in relation to lever handle 154 in a perspective, exploded view. These figures show the structural and functional relationships between the internal stabilizing screw 182, spindle male member 172, set screw 184, timing plate 126 and its tooth 132 in relation to operating the lockset and, in particular, eliminating handle wobble.

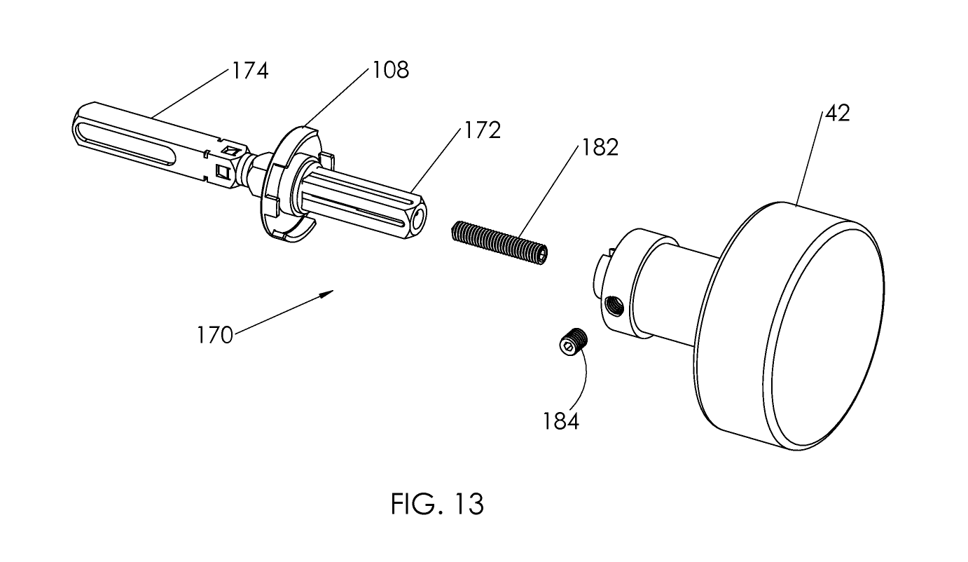

Referring to FIG. 13-15, spindle assemble 170 is shown in relation to knob handle 42 in a perspective, exploded view. These figures show the structural and functional relationships between the internal stabilizing screw 182, spindle male member 172, set screw 184, timing plate 108 in relation to operating the lockset and, in particular, eliminating the relative motion between the spindle and the handle.

Although specific embodiments of the invention have been described, various modifications, alterations, alternative constructions, and equivalents are also encompassed within the scope of the invention.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A concealed faceplate lockset comprising:
a latch;
a spindle;
a timing plate;
a first handle;
a second handle;
a concealed fastener mechanism connecting said first handle to said second handle through said spindle;
said spindle including a female member connected to said first handle and a male member connected to said second handle;
said male member having a longitudinal, threaded channel adapted to receive a threaded expansion screw, said expansion screw positioned in said channel and at its leading edge forcing expansion of said male member radially outward and preventing relative rotational motion between said spindle and said timing plate;
a second handle set screw;
said second handle having a threaded hole adapted to receive said second handle set screw, receiving said set screw; and,
said set screw tightened against said male member sufficient to eliminate relative motion between said second handle and said spindle.
